(19) United States
(12) Patent Application Publication
(10) Pub. No.: US 2023/0260737 A1
(43) Pub. Date: Aug. 17, 2023

(54) Long-LifeTime, Short Pulse, High Current Ion Source and Particle Accelerator

(71) Applicants: Mark Derzon, Albuquerque, NM (US); Paul Reynolds, Albuquerque, NM (US)

(72) Inventors: Mark Derzon, Albuquerque, NM (US); Paul Reynolds, Albuquerque, NM (US)

(21) Appl. No.: 18/176,567

(22) Filed: Mar. 1, 2023

Related U.S. Application Data
(63) Continuation of application No. PCT/US22/25148, filed on Apr. 16, 2022.
(60) Provisional application No. 63/176,272, filed on Apr. 17, 2021.

(51) Int. Cl. H01J 27/02; H05H 3/06

(52) U.S. Cl. CPC H01J 27/022; H05H 3/06

(57) ABSTRACT

Current state-of-the art ion sources do not meet multiple application needs for pulsed ion beams because current designs limit obtaining the needed peak currents, anode current densities, total currents, time averaged currents and lifetime in the same structure. High surface energy, power loading, material erosion and stresses damage surfaces. Our concepts for a ‘cold’ anode structure and ion source will reduce these erosion and damage issues. By extending lifetime and performance characteristics multiple applications can be enabled with lower maintenance and cost. The concepts here reduce the surface aging and provide the high performance (peak current, high current density and long lifetime required.

### TECHNICAL FIELD

This invention relates to the fields of ion beams, accelerators, ion sources and neutron generators.

### BACKGROUND

Various papers, patents, and other references are mentioned herein. Each is incorporated by reference herein. There are many ways to generate neutrons and many types of generators have been built. See, e.g., IAEA, Neutron Generators for Analytical Purposes, Vienna: International Atomic Energy Agency, 2012. p.; 30 cm.— (IAEA radiation technology reports series, ISSN 2225-8833; no. 1) STI/PUB/1535 ISBN 978-92-0-125110-7; J. Reijonen, “Neutron generators developed at LBNL for homeland security and imaging applications,” Nuclear Instruments and Methods in Physics Research Section B: Beam Interactions with Materials and Atoms, vol. 261, no. 1, pp. 272-276, August 2007, doi: 10.1016/j.nimb.2007.04.192; E. M. Oks, A. G. Nikolaev, V. P. Frolova, and G. Y. Yushkov, “Generation Of Deuterium Ion Beams By Vacuum Arc Ion Source With Deuterium saturated Zirconium Cathode *,” in 2017 IEEE International Conference on Plasma Science (ICOPS), May 2017, pp. 1-1, doi: 10.1109/PLASMA.2017.8496262. In almost all instances, such as in Brown, the ion source lifetime is measured in microseconds and longer, or long (seconds) of nanosecond bursts of neutrons. I. Brown, “Vacuum Arc Ion Sources,” CAS-CERN Accelerator School: Ion Sources—Proceedings, pp. 311-329, December 2013, doi: 10.5170/CERN-2013-007.311; US 2018/0247784. Those familiar with the state-of-the-art of neutron generators and ion beams will be applying the wrong situation to the content of this disclosure. The present disclosure focuses on very high current pulsed ion beams; these beams will scale high enough for Heavy Ion Fusion activities as well as, and specifically for, high current hydrogen isotope beams for intense neutron generation with short pulses. The present invention is applicable for intense beams with low cycle rates.

In the present disclosure, short pulses mean that the Full Width at Half Maximum is less than 1 microseconds (1 us). High current means more than 1 Ampere (1 A) peak current is created.

There are many applications for such beams. These include but are not limited to Heavy Ion Fusion, Light Ion Fusion, Neutron Generation, material characterization, detection of Weapons of Mass Destruction (WMD), the Strategic Space Defense and space travel. See, e.g., M. Okamura, “Laser ion source for high brightness heavy ion beam,” J. Inst., vol. 11, no. 09, pp. C09004-009004, September 2016, doi: 10.1088/1748-0221/11/09/C09004. A. Anders and J. W. Kwan, “Arc-discharge ion sources for heavy ion fusion,” Nuclear Instruments and Methods in Physics Research Section A: Accelerators, Spectrometers, Detectors and Associated Equipment, vol. 464, no. 1, pp. 569-575, May 2001, doi: 10.1016/S0168-9002(01)001437; T. H. Martin, J. P. VanDevender, G. W. Barr, S. A. Goldstein, R. A. White, and J. F. Seamen, “Particle Beam Fusion Accelerator-I (PBFA-I),” IEEE Transactions on Nuclear Science, vol. 28, no. 3, pp. 3365-3369, June 1981, doi: 10.1109/TNS.1981.4332106; L. A. Hamidatou, “Overview of Neutron Activation Analysis,” Advanced Technologies and Applications of Neutron Activation Analysis, March 2019, doi: 10.5772/intechopen.85461; T. Gozani, “Understanding the physics limitations of PFNA— the nanosecond pulsed fast neutron analysis,” Nuclear Instruments and Methods in Physics Research Section B: Beam Interactions with Materials and Atoms, vol. 99, no. 1, pp. 743-747, May 1995, doi: 10.1016/0168-583X(94)00675-X; https://www.history.com/news/reagan-star-wars-sdi-missile-defense; https://www.popularmechanics.com/science/energy/a34437026/direct-fusion-drive-interstellar-travel-saturn-titan. Another application is in the creation of Mo-99 and other isotopes for medical and other purposes. With this isotope source, isotopes of short half-life can be generated near the point of use. This minimizes the time to provide materials at the use point, shipping costs and risks, total time, total radiation burden, etc.

Recently the inventor has developed an application that requires a different style neutron source than those currently in demand. See, e.g., M. Derzon et al., “Short Pulse Active Interrogation System for Finding Fissile Materials,” Sandia National Lab. (SNL-NM), Albuquerque, N. Mex. (United States), SAND2019-7554C, July 2019. Accessed: Apr. 15, 2021. [Online]. Available: https://www.osti.gov/biblio/1641044-short-pulse-active-interrogation-system-finding-fissile-materials; “A Brief Overview of Research Into Radiation Source Development and Radiation Sensors in the Microfabrication Program at Sandia National Laboratories. Online: https://www.osti.gov/servlets/purl/1116398. See FIGS. 1 and 2.

The specific needs for this application are an intense (also sometimes called bright) neutron source able to make many neutrons of nearly monoenergetic energy, with brightness between 106 neutrons per pulse to over 1012 neutron/pulse with pulses of less than 10-6 seconds (<1 us). This means that the brightness varies from 1013 neutrons/sec to 1019 neutrons/sec. The spot size of this source can large or small depending on whether it will be used for imaging. The neutron tube must also have a long lifetime; this means tens of thousands of shots (not time in years). These numbers are significantly different than all the commercial or near commercial devices known in the art. In the historical context, where people have used reactors as well as DC beams, pulsed trains of neutrons, mostly these devices have mA beams on neutron generators and will not be relevant to the present disclosure because the time and current are at very different scales. Those beams also require low divergence ion beams, where divergence refers to the tendency of the beams to expand. M. S. Derzon et al., “Results of beam characterization measurements on PBFA II (abstract),” Review of Scientific Instruments, vol. 61, no. 10, pp. 3144-3144, October 1990, doi: 10.1063/1.1141711. For this application and in the present disclosure, we apply the source described to both focusing and defocusing beams. The reason for the focusing is to allow imaging where desired. The design tradeoff is that a focused beam has higher energy density and can do more damage to the materials which reduces lifetime. In the defocused beam generator we also describe below, or beam, we do not try to reduce divergence, sometimes also called permeance, because the application tube needs a longer lifetime (less damage) than it does increased brightness (number of beam particles/cm2/s) on the target.

There is another type of neutron source that is created in a dense plasma focus or DPF. The DPF works by generating a beam within an unstable plasma. See Ryutov, Derzon, Matzen, Reviews of Modern Physics, 2000) or Derzon, M. S., P. G. Galambos, E. C. Hagen, ‘Analytical Estimation of Neutron Yield in a Novel Micro Gas-puff X Pinch’. J Appl Phys (2012). This type of neutron generator can also work in the needed neutron brightness regime however the yield or number of neutrons created is highly variable and thus unsuitable for many applications.

As background for the initial application of this technology we are doing a variant of neutron activation analysis. The physics is applicable to many applications, for example ion beam hardening of surfaces, heavy ion fusion, etc.

We provide a good deal of background in the physics of use in this disclosure and refer to how the generators we describe in this disclosure relate to results in different system performance. We speak of system performance in not just the neutron generator function but in how we use the short pulse of neutrons generated. As such we refer to patent application ‘System, Algorithm, And Method Using Short Pulse Interrogation With Neutrons To Detect And Identify Matter’, U.S. patent application Ser. No. 16/433,576 as related to how a system can be used. Here we focus on the accelerator beam needed.

In 2012, Derzon, et al., SAND2012-8201C from Sandia National Laboratories, used a Time-of-Flight Technique to identify Special Nuclear Materials. More recent publications (Derzon, et al., 2017) and Podaly, et al., 2018) show compelling results for how fast emissions (<500 uS) can be used to find and identify materials. In the 2017 paper, Derzon, et al., showed the technique in a portable system. This technique is a much more efficient use of neutrons than existing and combined with some very different ways of performing the analysis and processing resulting in the improved performance that made it both portable and safer. This disclosure refers to the design of neutron generator tubes and pulsed power systems for meeting the short pulse interrogation need, however, the physics applies to many applications for intense ion beams. The reference literature is offered as background when trying to make a neutron source that operates as we describe. FIG. 1 shows a schematic illustrating how a bright burst is used to irradiate a sample and then both spectroscopy and time-of-flight methods are used to characterize a sample. Other applications can use the signal produced in other ways. A pulse for our purposes is an event which culminates in the generation of a short burst of neutrons (time FWHM^{˜}tens of nanosecond pulse width). When we are discussing long time or long-lifetime we are referring to the total number of shots that can be fired without maintenance or with only minimal maintenance. It is not the length of time the device can sit on a shelf or be used in the field like food; it is more like miles can be driven on a tire.

Neutron generators, in our case pulse power driven generators, are sometimes colloquially called diodes to be consistent with literature on the pulsed ion diode arena. Specifically, those we are discussing have primary power supply voltages of 80 kV to 300 kV operation. This is to make the rest of the system, meaning the ion source and the transport region, compatible with the lifetime limits and provide control of the amount of acceleration voltage needed to produce the desired number of neutrons and to control the neutron energy doppler broadening (a new term, which might not be significant unless we wish to optimize the time-of-flight performance).

The pulsed power can be driven by vacuum switches or electronic switches depending on the specific system design, and in general the pulsed power is considered almost a commodity for these designs at this time. This disclosure is focused on the technology in the particle accelerator or neutron generator tube itself.

Various technologies can facilitate acceptable neutron sources. There are a few generator styles able to make pulses of this duration. These are short pulse lasers, the dense plasma focus, and ion diodes. J. Alvarez, J. Fernández-Tobias, K. Mima, S. Nakai, S. Kar, Y. Kato, J. M. Perlado, Laser Driven Neutron Sources: Characteristics, Applications and Prospects, Physics Procedia, Volume 60, 2014, Pages 29-38, ISSN 1875-3892; V A Gribkov et al 2015 J. Phys.: Conf. Ser. 591 012020, ‘Dense Plasma Focus: physics and applications (radiation material science, single-shot disclosure of hidden illegal objects, radiation biology and medicine, etc.; D. Cook, et al, ‘Theory of applied-B ion diodes’, Phys. of Fluids B: Plasma Physics 1, 1709 (1989); https//doi.org/10.1063/1.858950. The lasers tend to be large and expensive and fairly fragile, the dense plasma focus has a large amount of scatter in its production from shot to shot and they have a fairly limited lifetime due to material erosion, for the application we have in mind. The limitations in prior generator developments, whether at current constant operation conditions or in a pulsed mode, have been lifetime of the tube, size of the power size at the target (how large the actual spot size is) and the energy storage systems. The highest average yields were obtained on the Rotating Target Neutron Source at Lawrence Livermore National Laboratories. D. W. Heikkinen, “RTNS-II (Rotating Target Neutron Source II) operational summary,” International conference on the application of accelerators in research and industry, Denton, Tex., USA, 7 Nov. 1988, Sep. 1, 1988. https://digital.library.unt.edu/ark:/67531/metadc1193925/(accessed Dec. 6, 2020).

An appropriate generator for our purposes is a variant of the ion diode. So named because they are off—then on. See papers regarding the light ion fusion program at SNL and magnetically-insulated diodes. DPF's and pinch variants have also been proposed (see papers by Podaly, Krishnan, Ryutov, Derzon, Gribkov, etc.).

### DISCLOSURE OF INVENTION

Embodiments of the present invention provide an apparatus comprising (a) a cold anode ion source as described herein; (b) an accelerator; (c) a target; (d) a control system configured to produce short pulses. In some embodiments, the control system is configured to produce pulses having full width at half maximum less than 1 microsecond. Some embodiments further comprise a detector. Some embodiments further comprise an optical system configured to heat the anode by directing light to the anode along a different path than that taken by ions emitted.

Embodiments of the present invention provide an apparatus comprising (a) an ion source, comprising an anode and a cathode; (b) one or more power transmitting surfaces; (c) a light source; (d) one or more focusing elements, configured to focus light from the light source onto the anode along a path distinct from that taken by emitted ions; (e) a vacuum region; (f) a timing control unit configured to generate pulses having full width at half maximum of less than 1 microsecond.

Some embodiments further comprise an electron repression grid. In some embodiments, the light source is configured to provide uniform illumination to the anode. In some embodiments, in operation the anode produces an anode plasma sheath, and wherein the cathode is configured to provide uniform electron flow over the anode and the anode plasma sheath.

### BRIEF DESCRIPTION OF THE DRAWINGS

FIG. 1 is an illustration of a schema for the detection and identification of materials.

FIG. 2 is an illustration of the timeline of major events.

FIG. 3 is an illustration of a generic LoLIPP diode.

FIG. 4 is an illustration of a pulsed power system.

FIG. 5 illustrates an accelerator tube with additional support components for vacuum pumping and cooling if necessary.

FIG. 6 is an illustration of a sealed vacuum tube embodiment.

FIG. 7 is an illustration of a one-side LoLiPP diode.

FIG. 8 is an illustration of a two-sided LoLiPP accelerator.

FIG. 9 is an illustration of a barrel focusing geometry.

FIG. 10 is an illustration of a shaped target.

FIG. 11 depicts design features and scaling.

FIG. 12 illustrates multiple embodiments of surface structures for mild field enhancement.

### INDUSTRIAL APPLICABILITY AND MODES OF CARRYING OUT THE INVENTION

A diode suitable for the applications described above needs to be dramatically different than those discussed in the literature—it needs to have long-life meaning capable of many shots—not shelf-life—a common miscommunication, and the divergence can be high for most embodiments. Only in the situation where a point source is required (for imaging purposes, a low- to moderate divergence is required) is divergence important. The difference in designs is shown in the text and figures below. The present invention provides for multiple instances. A design tradeoff is in the definition of long-life—the focusing geometries can all employ an easily maintained target or one where the generator cathode is rotated or otherwise renewed when needed.

The present invention contemplates several embodiments of ion diodes that can be used for different use cases in the development of methods for nuclear activation analysis or the other applications mentioned above. These efficiently provide electrical energy conversion into high energy ions or electrons (with reversed polarity). The methods will work under appropriate conditions for solid surface ion source and for gas surface ion sources. Both surface-based (or solid surface) sources and gases can be used as the source of ions. The specific designs are dependent upon the end-use and system tradeoffs. In aggregate the methods used cover a wide range of beam parameters. The efficiency is needed in each component of a generator design to accommodate the relatively long-life, short pulse conditions required by the applications.

The present disclosure provides advances in the three elements: ion source, transport, and target. The present disclosure describes them as part of a system although each can provide advantages separately.

Each pulsed ion beam system is a little different. For purposes of this disclosure, consider it as comprising three main components. These are:
a. ion sources designed for specific purposes.
b. transport region
c. a target.

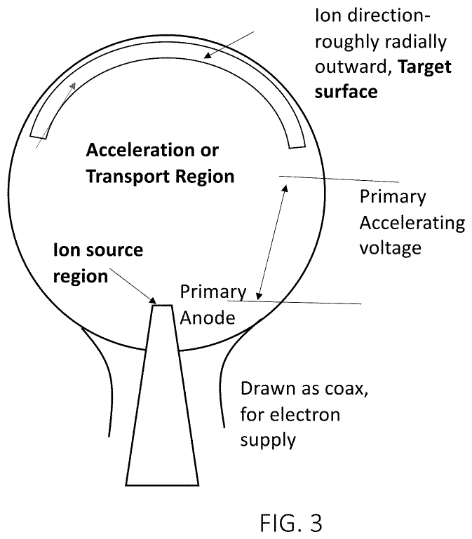

In FIG. 3 we show notable elements of example embodiments; in FIG. 3 a generic LoLiPP diode, refocusing geometry. The figure contains schematic information regarding control of the location for a source, a transport region and a target, is compact and offers the necessary bright (high neutron yield) and short pulse width (<1 us) that our application prefers. In addition, a notable feature is that the physics we describe here provides design features that can be scalable over roughly a factor of one million in yield by changing physics parameters of the diode and the pulse power system. A LoLiPP diode as in the figure comprises: Large area ion source (to keep heating small and cooling straightforward), Large area cooled target, Relatively low transport electric field (arc constraints reduced), Coaxial vacuum feedthrough, Independent power supplied for ion source if non-MITL/lithographically fabricated/micromachined or traditionally machined source design. Electron reflection mesh at target and source detail are not shown in the figure. The apparatus shown in the figure comprises an ion accelerator.

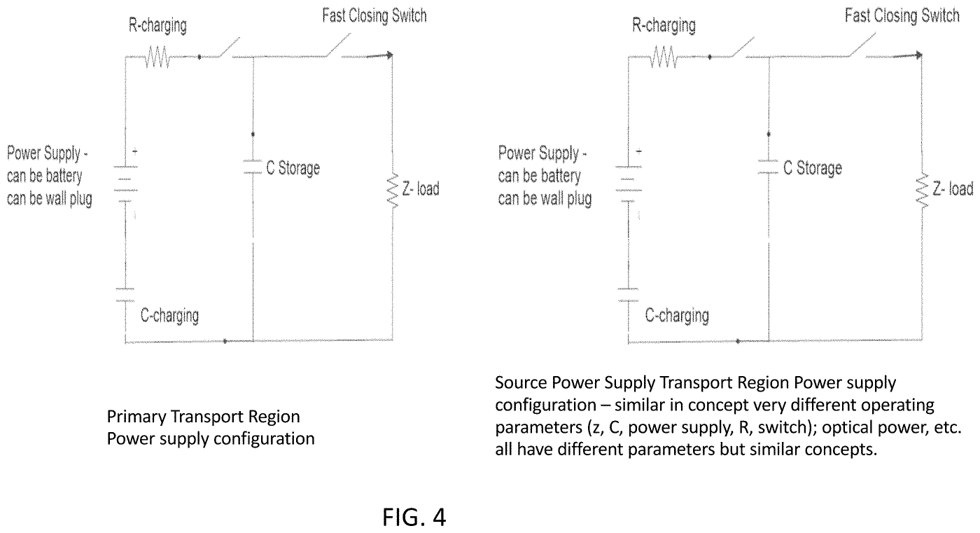

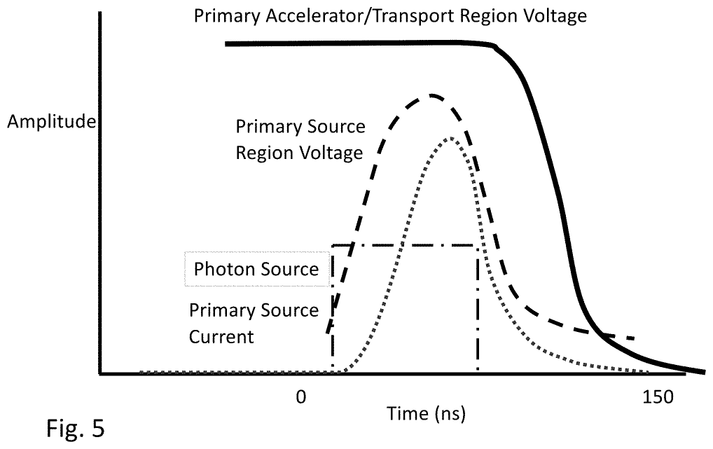

The invention contemplates both multiple beam transport concepts (a defocused beam for longest-lifetime maximizing lifetime) and a focused beam where spot size is important to enable imaging. The invention contemplates two types of ion source designs. These designs can reduce surface heating. One utility difference is that some applications cannot support the power/system-volume or mechanical robust requirements of gas handling and are willing to accept shorter lifetime as system tradeoffs. A generic pulsed power system is shown in FIG. 4 to provide an idea of a simple power source. Different power supplies can be used to power different elements of the system. The two for the primary acceleration grid and voltage for the source are different in terms of the parameters but similar in structure. The electrons for the other elements (such as the photon source) are not described in the system since the circuitry is well known in the art. The time histories of the key pulses/power/voltage are important for the non-thermally heating of what becomes the ion source. A schematic time history is shown in FIG. 5.

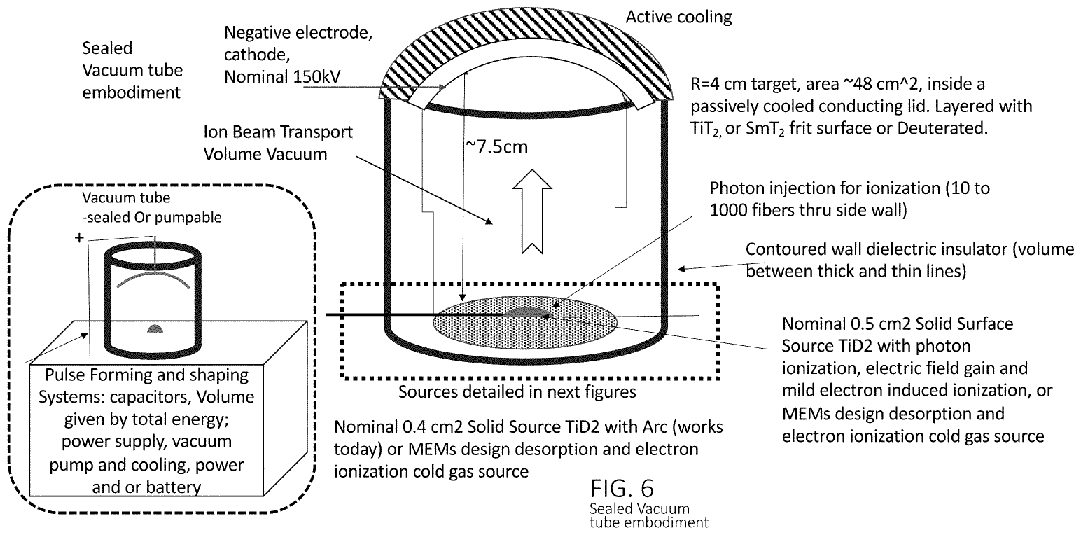

Variations of the overall system also include one which uses a solid substrate in order maintain the long-lifetime requirements in a sealed system. The other employs a more complex system involving a gas as the source of ions, rather than a solid surface. It brings with it the need for a gas handling, pumping and cooling infrastructure. The solid surface design can be suitable for low power, portable systems and the more complex system can enable longer lifetime, lower maintenance, and more intense beams. Another variant can use a shaped anode surface and focusing electric/magnetic fields which will create a higher current density at the target, limiting lifetime but enhancing the performance of an imaging system. Shaping the anode and adjusting the transport features are aspects we incorporate into the long-life diodes and can be done with gas or solid surface sources. FIG. 6 illustrates an accelerator tube with additional support components for vacuum pumping and cooling if necessary.

One approach useful in the creation of intense long-life accelerators as described here is keeping the surface and bulk temperatures low and limiting the stress caused by magnetic fields to those which will not damage the surface configurations or cause depletion of either the source material or target material. This can be done by providing a large area source which is non-thermally heated and the desired beam particles are preferentially ionized.

At the source, we do this through a balance of controlled optical ionization, controlled electron field generation and the creation of a proportion/ionizing/avalanche generating region. A tertiary effect of heating and material damage is material erosion of surfaces from heating moves material around inside the tube; this eroded material deposits on places it is not wanted and can degrade performance over time. This is preferably minimized. At the target we increase the surface area by adding controlled texture to ‘see’ the beam so the heat load per unit area is reduced. We also provide means of refreshing the surfaces and low effort replacement of parts.

Initially, semi-static electric fields of the primary anode cathode are generated, as well as the accelerator grid from the secondary anode (which is also the primary cathode). These bias fields are applied at nearly the same time as the photon source is supplied to the primary anode surface and/or gas volume. The first ionization in the system happens under non-LTE conditions, as an LED/laser/flashlamp can be used to preferentially excite the ion of choice over a large region of the source; more typical flashover type electron motion generates ionization as well. Coupled inductance (not shown) between the electrodes provide dynamic charge to avoid local Child-Langmuir current saturation effects. This does not fully ionize the system by design. We create just enough ionization that the electron flow between the primary anode and cathode (a mesh) is enough to generate a non-thermal heating of the preferentially ionized beam material and the bias between the primary anode and mesh accelerates ions through the mesh.

For the currents we are generating, starting at tens of Amperes to over MegaAmps peak, there are other features we can adjust for. These include beam motion as current varies with voltage and time, for the beam (and within it little beamlets). We also control the electron emission which can give rise to too much surface heating. Magnetically insulted transmission lines, whereby high magnetic fields in regions where there is high voltage control the electron transport, of order Volts/Amp or MV/MA (mega-volt per megaAmp) per unit current flow can be useful for creating ion sources. However, they can damage surfaces and the high magnetic fields can warp materials. We do this by adding sharp features which will create controlled high-electric field multiplication regions. Instead of trying to make nanotips (see Hertz, Resnick, et al), or Schoenfield, et al.) which heat and fail, we create large areas at lower electric fields and do not rely upon electric field ionization or desorption. The high electric fields act as the field in an avalanche or GEM (gaseous electron multiplier).

Ion diode concepts have been used in the past. M. S. Derzon et al., “Results of beam characterization measurements on PBFA II (abstract),” Review of Scientific Instruments, vol. 61, no. 10, pp. 3144-3144, October 1990, doi: 10.1063/1.1141711; M. E. Cuneo et al., “SABRE extraction ion diode results and the prospects for eight ion inertial fusion energy drivers,” in IEEE Conference Record Abstracts. 1999 IEEE International Conference on Plasma Science. 26th IEEE International Conference (Cat. No. 99CH36297), June 1999, pp. 275-, doi: 10.1109/PLASMA.1999.829621. These methods were not employed in the same manner we are employing them. Instead, the present embodiment provides short pulsed long-life particle accelerators generators. We describe in detail tubes with both initially solid ion sources, liquid, and gas. We present transport regions specific to meeting the long lifetime needs of these tubes, with cooling, and packaging for low cost refueling and replacement. For a neutron generator accelerator biases of 60-300 keV are most advantageous. For other applications such as an isotope generator where perhaps 25 MeV are desired the transport region geometry and complexity will be more involved.

Accelerators and neutron generators have been built before and we are moving the rhetoric to unique features included in embodiments of the present invention. Now that we have described some of the elements of the Long-Life Pulsed (LoLiPP) particle accelerator, additional detail on the generic elements will be provided. FIG. 6 above depicted a generic LoLiPP ion accelerator as a neutron generator.

For clarity and simplicity, we do not show an electron reflection grid near the secondary anode (the target) which reduces the secondary electron backscatter off the anode surface. That style mesh element is in use elsewhere in a similar manner as in the present invention.

Embodiments of the present invention provide systems enabling these to be long life, at very high peak currents (>10 Amps), stable/consistent amounts of beam current and peak current densities greater than ten Amps per centimeter squared. Embodiments of the present invention provide long-life neutron tube version of the particle accelerator with the dominant elements shown.

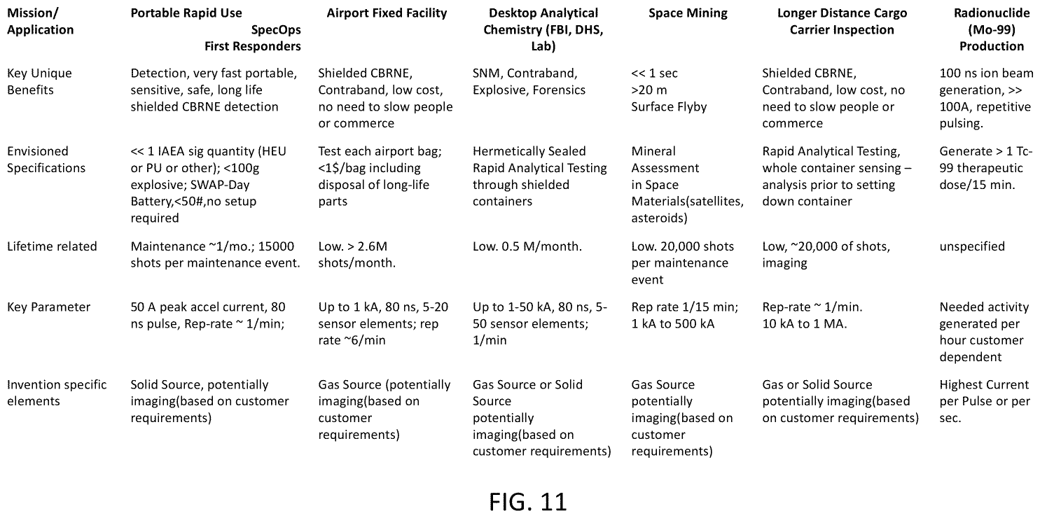

The system can be scaled to multiple values of peak current and designed for a range of total neutron yields where the specific heating rates are controlled to provide long-life in each element. Example embodiments of this scaling are shown in the figures. Certain elements such as the mesh surface and target surfaces are preferably designed for rapid replacement and long operational lifetimes. The figures illustrate a range of embodiments all of which work and offer advantages under different circumstances to fill out the phase space defined by FIG. 3. Those circumstances are determined by the tradeoff space of system volume, lifetime, angular dispersion requirements, neutron or x ray footprint and neutron source spot size. For the other missions/applications of this technology we refer to FIG. 11, which clarifies some of the design features which can be scaled to enable new uses.

Under focusing or defocusing geometries and ion source specific design we use techniques not employed in the literature to enable the system. The matrix below, Table 1, describes concepts that contribute to the long-life diode, source, and target elements.

TABLE 1
Matrix gas vs solid surface role.

| | | Gas Source, |
|---|---|---|
| | | Surface or Both |
| Invention | Method | (G/S/B) |
| Non-thermal Large Area Source | Controlled electron deposition, photon | B |
| excitation | ionization, electric field multiplication | |
| Maximum Surface area exposure at | Fritted, machined, or lithographically | B |
| target and maximized thermal | structure surfaces | |
| conduction and/or cooling at | | |
| cathodes and anodes | | |
| Gas Puff Source | Valve (MEMs or traditional), w or w/o gas | G |
| | cooling to increase temperature | |
| Replaceable Source mechanism | Rotation w/in vacuum or requiring | B |
| | automated replacement or substitution | |
| Replaceable Target Mechanism | Rotation w/in vacuum or requiring | B |
| | automated replacement or substitution | |
| Controlled and limited direct heating | Electron flow and energy deposition on | B |
| on anode surface | anode is limited based on structured | |
| | surface for cathode emission. | |

Specifically, lifetime is determined by factors that include: (1) source loading—the actual number of source ions available, (2) heating causing damage of the materials, (3) aging of the dielectric materials, (4) target loading, the number of target species available in the target, (5) focusing of the source ions onto the target, (6) cooling of the materials.

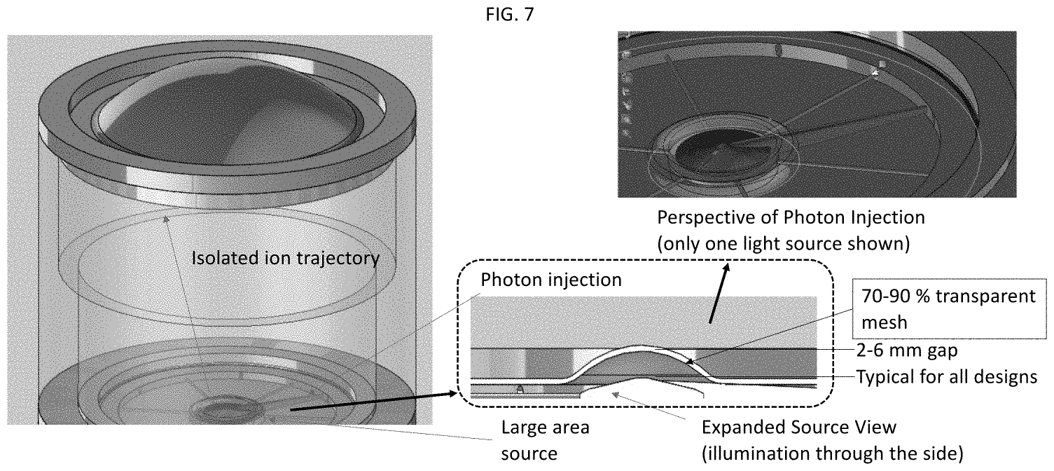

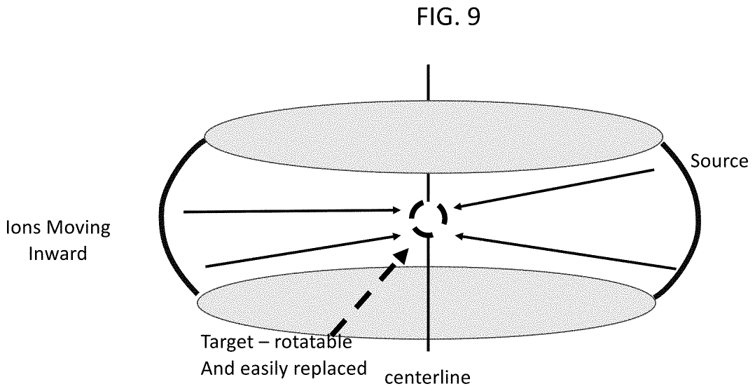

In FIGS. 7, 8, 9, and 10, we clarify some key geometric issues to the device/accelerator/generators disclosed as example embodiments. There are drawings explicit to each source type; source and accelerator components will be determined by the specific application (e.g. lifetime, fieldability and usage needs). FIG. 11 summarizes this. FIG. 7 illustrates an embodiment including a one-side LoLiPP Diode, defocusing geometry. The beam does need to focus in this example, and as the primary beam aiming changes because the beam voltage is dropping the beam strikes a larger area of the target or anode reducing the peak heating at any point. FIG. 9 illustrates an exemplary ‘Barrel’ Focusing Geometry, inward focusing beam with a shaped target to minimize energy deposition/er area and improve replacement/maintenance costs. FIG. 11 illustrates an example of a shaped target to increase angle of approach, to control yield and reduce heating/area while maintaining small spot size and easy to replace—used primarily for imaging (x ray, neutron, gamma, radiography).

There are several main components in an example embodiment of a neutron generator system, including the acceleration region, the target, and the ion source.

Embodiments disclosed herein include features that lead us to name the variations of the ion diode a LoLiPP diode. LoLiPP stands for Long Life Pulsed Power diode or accelerator.

Example embodiments of the present invention provide methods to obtain solid and gas ion source performance and lifetime, extended lifetime transport region with relative low breakdown conditions, large area source and target with active coiling where needed as well as gas tube pumping and elements for refurbishment without automatic destruction. There is a focusing geometry design for when lifetime can be reduced in favor of imaging nuclear activation target.

Note that most ions beams operate over long times (seconds—years) compared to the example embodiments disclosed herein, and at much lower total currents (microamp vs tens to megaAmps). These features of example embodiments reduce the heating and it is both the heating and magnetic fields (which generate stresses) which cause most damage and limit lifetime. Materials erode, tips deform, surfaces warp. For many applications, the total current (in Coulombs) may be similar.

Thermal heating, ion desorption or electric field desorption are used to create ions that then flow into an acceleration region. Embodiments of the present invention employ three techniques to reduce bulk heating and create highly non-thermal ionization to generate the ions which get accelerated. Another way of looking at this is temperature is a means of describing the equilibrium condition. All the electrons and atoms get heated when raising temperature to generate the free ions and electrons. This takes energy and contributes to the damage. For our purposes we can do non-thermal processes to initiate an electron multiplication process in a non-thermal manner to preferentially heat the material which becomes the ion beam or ions accelerated in the transport region. Examples of non-thermal processes include:
(1) laser ionization tuned to the source material (for instance the 656 nm absorption feature in Deuterium gas), or highly absorbing materials loaded with the target ion, we feed this into the system via fiber optics, lenses coupled to either fiber sources, laser diode stacks, or tuned flashlamp.
(2) electrons emitted from shaped cathode structures and fields meant to controlled interactions with the anode surface, sheath plasma or gas puff via magnetic field control structures (see literature in MITLs; these features are most useful in the higher current density systems).
(3) direct electron desorption off cathode surface (these electrons act much like those in a GEM (gaseous electron multiplier) or flashover ion source systems, used to generate gain, here we use them as massively scaled electron sources for ionizing the ion source. A variant of this could be used to create an intense electron beam.
(4) mild heating at tips to evolve initial gas and induced arcing off thermal source (like a spark plug)—this will provide long-lifetime systems because the bulk of the heating is done in the gas source not at the surfaces.

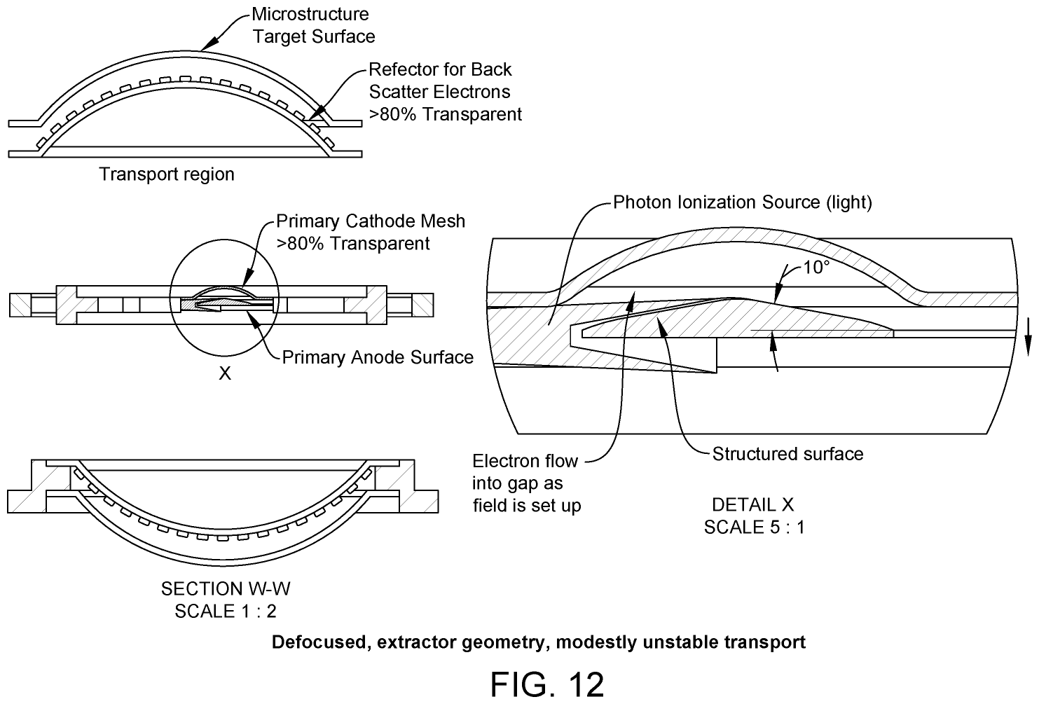

Some of the early figures mention photon induced ionization (use fiber optic injection either onto solid surface or into gas region of ion source creates non-thermal modestly ionized material). Because of a relatively low initial ionization the material may not fit the definition of a plasma due to low overall ionization. However, enough free electrons can be generated at the local high electric fields to create a multiplication or avalanche effect in the surface released gases or in the gas itself if there is a flowing gas volume over the tips. An example embodiment, for a compact application, is shown in FIG. 12 of the photon injection into a defocused solid surface long life or many shot, diode. The figure is meant to graphically clarify the specific physics to generate the non-LTE and low areal heating mechanisms in the ion source. A high slew rate of electric field in the primary (source) acceleration region will generate a few ionizations or Townsend mechanism avalanches. Fully formed they can be an extended and considerable source of heating, this is like what are called ‘flashover’ sources in the literature and we control them by having limited applied magnetic field in the anode-cathode gap region and controlled electric field multiplication at the cathode. The primary control of non-thermal behavior is photon injection (depending on cost and size of the total system) at wavelength matching the ionization needs of the ion (or electron) for accelerated species. Lasers, LEDs, and flashlamps can be good choices depending on the goal. These short bursts of light create a controlled amount of ionization in the gap and on the surfaces. From the ionization loci full or partial avalanches generate the bulk of the controlled ionization and the field pulls the ions into the acceleration region. Preferably, excess gas is not introduced into the tube and acceleration region. This is the driver behind using fast gas puffs or solid surfaces as the initial source of ions.

The surface has been designed to increase electric fields in local regions drawing enough ionization to create the avalanche or proportionality in the ion density formed to meet the beam current densities required. This is because the ion source is scalable in area for very high peak currents and high current densities (>0.5 A/cm2) with large total anode area. This enables multiple embodiments and applications. There is a good deal of energy per pulse from all mechanisms, which is a significant feature that we minimize that heating per accelerated particle we generate. The acceleration region also requires a great deal of energy per pulse. The amount of energy required to make an individual ion much higher than the energy to create a single accelerated ion. Crudely speaking, in many beams the energy to create the ion beam at the source is roughly the same as the energy deposited at the target. Depending on the specific application and design this number can be a factor of 10 lower or higher. It is a significant reason that there will be a great deal of heating at the target and that there is a high potential for heating to damage the surface. Preferably, the surface structure and shape is configured to reduce the specific heating and damage at the surface.

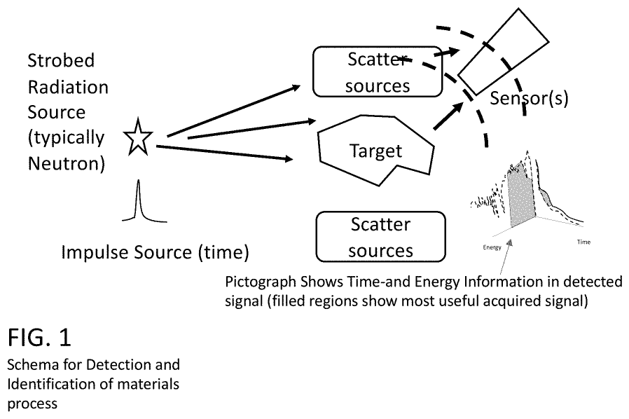

FIG. 1 illustrates a basic layout for an embodiment of a short pulse of a target irradiation with a strobed neutron (10's of ns Full-Width Half-Maximum neutron burst generated with an ion beam). The outgoing neutrons illuminate the target and sensors pick up reflected and generated signal both from neutron-gamma interactions and neutron scattering. Processing and design of instruments allow the prompt pulse from the target be separated from the signal from the source.

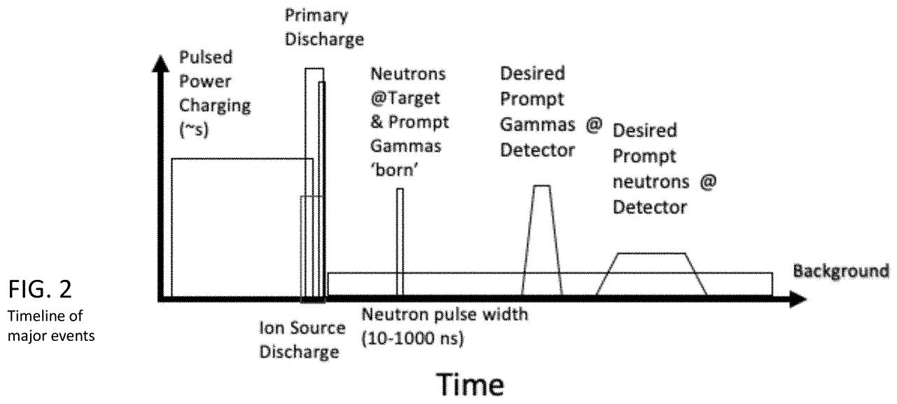

FIG. 2 shows an example timeline separating the various physics features. These features provide the physics that makes this method of performing nuclear activation analysis so much more effective, faster and safer than other methods. This is provided just as an example to show how a short pulse adds value. There are analogous concepts for each of the other applications mentioned.

FIG. 3 is an illustration of the basic elements of an example embodiment of a LoLiPP Diode and particle accelerator.

FIG. 4 illustrates an embodiment of a simple pulsed power driver configuration. This generic layout can work for any of the tube designs. Not shown, a divider and pulse shaping circuit, which can be used to power the ion source separately from the main beam accelerator voltage. The primary voltage across the fast-closing switch will generate the full system voltage.

FIG. 5 illustrates exemplary time-histories for the primary current and voltage parameters.

FIG. 6 illustrates example system components for LoLiPP Anode design in a compact long-life neutron generator. On the bottom a power coaxial transmission line brings in the primary acceleration voltage and current. Other applications require engineering modification necessary to the application. The figures illustrates an example of a LoLiPP Diode—Envisioned Embodiment with Solid Ion Source and Sealed Tube for portable use with in-field maintenance; nominal 50-200 A ion current, 150 kV, acceleration current, ^{˜}80 ns pulse; examples scaled for neutron generator.

FIG. 7 illustrates an example embodiment of a solid anode electron beam heated intense nominal 1 cm\hat{ }2 source with 2 kVcm-20 kV/cm acceleration region, 2-4 kV/cm across source gap. Pulsed power not shown. This example shows a sealed tube embodiment (useful in portable system designs). The optical light in this example is nearly grazing incidence to the surface to minimize volume and complexity. For other embodiments it can be appropriate to bring the light into the source at higher angles (not shown).

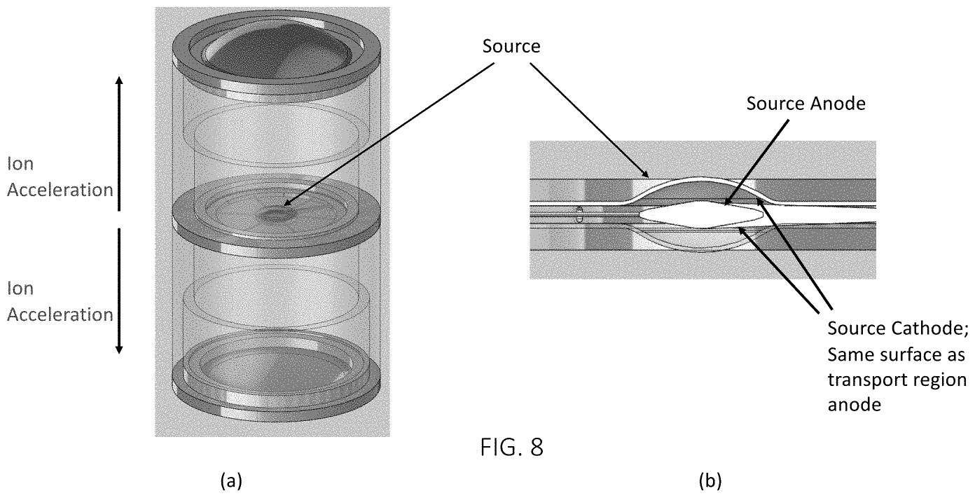

FIG. 8, on the left side shows a schematic of an example embodiment of a two-sided LoLiPP accelerator. This example makes efficient use of electronic components and optimizes system volume for a given amount of beam. The right side shows the symmetry illustration of a source anode floating between dual sided mesh structures.

FIG. 9 illustrates an example of a ‘Barrel’ focusing geometry, including an inward focusing beam with a shaped target to minimize energy deposition/er area and improve replacement/maintenance costs.

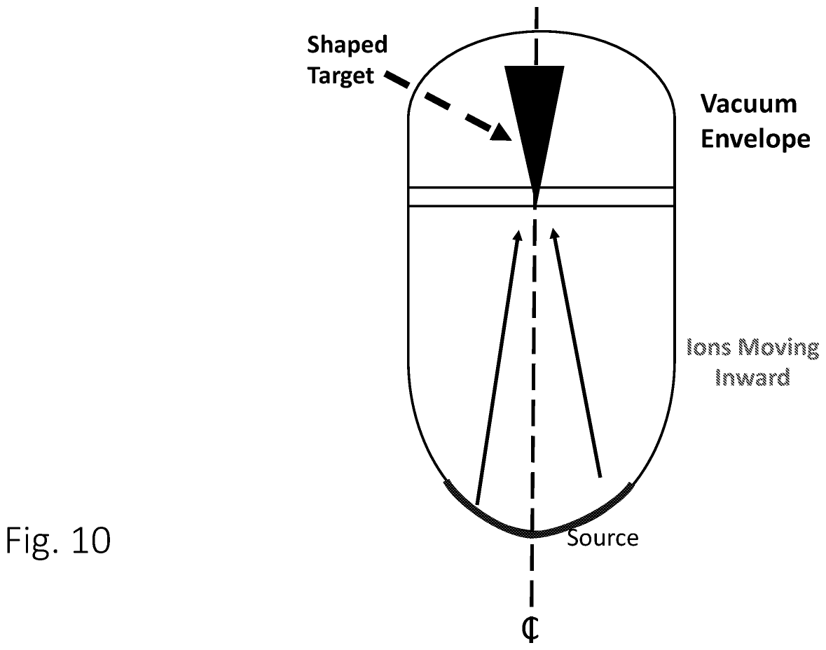

FIG. 10 illustrates an embodiment with a one-sided ‘Extractor’ focusing geometry, having an inward focusing beam with a shaped target to minimize energy deposition/er area and improve replacement/maintenance costs.

FIG. 11 comprises a matrix describing a number of example applications and how variations in design allow the invention to be used in many ways. Long-range sensing for space mining, with minimal maintenance requirements and straightforward maintenance. Column D. An important mission here is much higher total beam current than the other options, short rate however can be lower. Utilization in space means there is little opportunity for maintenance and power usage must be minimal. To this end in certain embodiments both the source and target require high loading in the ion source however as it is in space the tube sealing can be different and the tube can be vented to space to allow for Tritium-decay to He to be vented and avoiding tube some tube lifetime issues. Cooling of the source and target is still required to reduce boiling off the D and T isotopes from the source and target. Long distance material detection requires higher neutron yield, moderate shot rate diode and long-life constraints will require a larger transport region and target. The diode in certain embodiments will require higher current density at the ion source to create more neutrons from a compact neutron generator and we have designed a magnetically-insulated variant ion-source in order to provide the necessary electron ionization and source current. Because of the high yields, activation will become an issue at the target side and the target will need automated rotation/maintenance. The source itself in this example will also be subjected to enhanced heating and relative frequent maintenance but the design showed can allow for automated replacement and little handling to maintain safety.

FIG. 12 is embodiment of a large area Child-Langmuir enhanced ion source ultimately suitable for a 30 A peak current beam on a solid surface anode.

Embodiments of the present invention can provide:

A system for a long-life, high peak current particle beam accelerator.
A system for a long-life, scalable peak current and anode area intense particle beam accelerator.
A system for a long-life, scalable current intense particle beam accelerator for imaging (x ray, gamma, proton, electron, etc.).
A scalable area high current intense particle beam source capable of accelerating, electrons, protons, He, and other ions.
A non-LTE low energy deposition ion and electron source of scaleable peak current and peak current density.
A high Intensity beam particle source with multiple-ionization methods to improve lifetime and performance.
A focused ion beam at high peak current and high current density for heavy ion fusion.
A focused ion beam at high peak current and high current density for small scale isotope manufacture.
A focused ion beam at high peak current and high current density for kinetic energy weapons.
A neutron generator of reproducible yield and lifetime appropriate for portable detection of Special Nuclear Weapons and CBRNE threats.
A system for a long-life high current particle beam accelerator.
A system for a long-life very bright particle generator for Tc-99/Mo-99 and other medical isotope generation.
A system for a long-life very bright neutron generator.
A scalable area cold plasma ion source.
A long-life, scalable-area ion source.
A long-life (many shot) target for an ion beam.
A bright (n/s), compact, short pulse nearly-monoenergetic neutron generator.
A gaseous ion source design, characterized by electron surface heating using a mild magnetically insulated transport.
A gaseous ion source design, characterized by electron surface heating using a mild magnetically-insulated transport.
A fritted hydrogen-isotope structure solid surface for long-lifetime operation at high current density (>1 A/cm\hat{ }2.
A gaseous ion source design, characterized by electron surface heating using a mild magnetically-insulated transport.
A short transport region for unfocused ion beam transport to a target in order to limit heating at the target. Roughly half of the system power is input at the source. The other half occurs at the target end. A defocused beam or a beam which moves in time across the target region will have much lower energy density at the target and this is why this is done. We electrostatically draw the beam across the surface as the bias voltage changes the beam steering changes as well.
A method and embodiment for gas ionization and extraction during for a long life, >1 A/cm\hat{ }2, short pulse ion source using electric field multiplication of photon induced ionized gas, supplemented with magnetically-controlled electron enhancement.
A method and embodiment for gas ionization and extraction during for a long life, >1 A/cm\hat{ }2, short pulse ion source.
A gaseous ion source design, characterized by electron surface heating using a mild magnetically-insulated transport.
An solid surface ion source design, characterized by electron surface heating using a mild magnetically-insulated electron transport to maximize source lifetime.
A method for ultrahigh rate material identification (nuclear material, or chemical), via spectroscopic and time varying emission rates.
Combined ability to enhance the identification of materials with any or all the methods (energy spectroscopy, timing or emission features, and imaging.
Rotatable target for long life usage without tube replacement or service.
Rotatable source substrate for long life usage without tube replacement or service.
In-field replaceable accelerator tube for low cost operation and in-field life enhancement. Gas Phase Ion source with low surface heating and ultralong, low maintenance lifetime.

The present invention has been described in connection with various example embodiments. It will be understood that the above descriptions are merely illustrative of the applications of the principles of the present invention, the scope of which is to be determined by the claims viewed in light of the specification. Other variants and modifications of the invention will be apparent to those skilled in the art.

What is claimed is:

1. An apparatus comprising:
(a) a cold anode ion source as described herein;
(b) an accelerator;
(c) a target;
(d) a control system configured to produce short pulses.

2. The apparatus of claim 1, wherein the control system is configured to produce pulses having full width at half maximum less than 1 microsecond.

3. The apparatus of claim 1, further comprising a detector.

4. The apparatus of claim 1, further comprising an optical system configured to heat the anode by directing light to the anode along a different path than that taken by ions emitted.

5. An apparatus comprising:
(a) an ion source, comprising an anode and a cathode;
(b) one or more power transmitting surfaces;
(c) a light source;
(d) one or more focusing elements, configured to focus light from the light source onto the anode along a path distinct from that taken by emitted ions;
(e) a vacuum region;
(f) a timing control unit configured to generate pulses having full width at half maximum of less than 1 microsecond.

6. The apparatus of claim 5, further comprising one or more detectors.

7. The apparatus of claim 5, further comprising an electron repression grid.

8. A cold anode ion source as described herein.

9. The apparatus of claim 1, wherein the anode comprises an anode as claim 8.

10. The apparatus of claim 1, wherein the light source is configured to provide uniform illumination to the anode.

11. The apparatus of claim 1, wherein, in operation the anode produces an anode plasma sheath, and wherein the cathode is configured to provide uniform electron flow over the anode and the anode plasma sheath.
